(19) United States
(12) Patent Application Publication
(10) Pub. No.: US 2017/0039935 A1
(43) Pub. Date: Feb. 9, 2017

(54) DISPLAY PANEL AND PIXEL CIRCUIT

(71) Applicant: GIO Optoelectronics Corp., Tainan City (TW)

(72) Inventors: Wu-Chang YANG, Tainan City (TW); Chia-Ho YANG, Tainan City (TW)

(21) Appl. No.: 15/227,244

(22) Filed: Aug. 3, 2016

(30) Foreign Application Priority Data
Aug. 4, 2015 (TW) 104125303

(51) Int. Cl. G09G 3/3233; G09G 3/32

(52) U.S. Cl. CPC G09G 3/3233; G09G 3/32; G09G 2310/06; G09G 2320/0247

(57) ABSTRACT

A pixel circuit includes a lighting element, a driving signal generating unit and a switching unit. The driving signal generating unit compares a data signal with a reference signal so as to generate a PWM driving signal. The status of the PWM driving signal is determined according to the comparing result of the data signal and the reference signal. The switching unit is electrically connected to a power source and the lighting element, and generates a driving current to drive the lighting element to emit light according to the PWM driving signal.

### CROSS REFERENCE TO RELATED APPLICATIONS

This Non-provisional application claims priority under 35 U.S.C. §119(a) on Patent Application No(s). 104125303 filed in Taiwan, Republic of China on Aug. 4, 2015, the entire contents of which are hereby incorporated by reference.

### BACKGROUND OF THE INVENTION

Field of Invention

The present invention relates to a pixel circuit and, in particular, to a pixel circuit of a LED display panel.

Related Art

FIG. 1A is an equivalent circuit diagram of a conventional analog driving OLED pixel. As shown in FIG. 1A, the conventional OLED pixel 10 can be applied to a display device and include transistors 102 and 104. The source of the transistor 102 is electrically connected to a data line 112, and the gate of the transistor 102 is electrically connected to a scan line 114. Besides, the drain of the transistor 102 is electrically connected to the gate of the transistor 104, and the drain and source of the transistor 104 are electrically connected to a power source VDD and an OLED 106, respectively.

When the scan line 114 is enabled, the transistor 102 is turned on. The data signal voltage Vdata is transmitted from the transistor 102 to the gate of the transistor 104. Then, the transistor 104 is enabled according to the data signal voltage Vdata, and generates a driving current I1 to drive the OLED 106 to emit light according to the power source VDD. Accordingly, the level of the driving current I1 is determined based on the level of the data signal voltage Vdata instead of a constant current. This variable driving current I1 may cause the damage of the transistor 104 and the OLED 106, thereby decreasing the lifetime of the component.

FIG. 1B is an equivalent circuit diagram of a conventional digital driving OLED pixel. As shown in FIG. 1B, the conventional OLED pixel 14 can be applied to a display device and include a driving circuit 142, a transistor 144 and an OLED 146. The driving circuit 142 is electrically connected to a scan line 142 and a data line 154. Besides, the driving circuit 142 is further electrically connected to the gate of the transistor 144. The source of the transistor 144 is electrically connected to a power source VDD, and the drain of the transistor 144 is electrically connected to an OLED 146.

FIG. 1C is a signal timing chart of the OLED pixel 14. Referring to FIGS. 1B and 1C, when the scan signal Scan is enabled, the driving circuit 142 outputs the switching signal SW to the gate of the transistor 144 according to the data signal voltage Vdata. If the switching signal SW is a low level voltage, the transistor 144 is turned on so that the driving current Idrive generated by the power source VDD can drive the OLED 146. Since the voltage of the switching signal SW is constant, the driving current Idrive is also constant.

In the digital driving OLED pixel, the brightness of the OLED 146 is related to the duty cycle of the switching signal SW. As shown in FIG. 1B, when the duty cycle of the switching signal SW is longer, the brightness of the OLED 146 is lower. On the contrary, when the duty cycle of the switching signal SW is shorter, the brightness of the OLED 146 is higher. As shown in FIG. 1C, the duty cycle of the switching signal SW in a frame F1 is very long (e.g. 75%), so the OLED 146 can only be lighted within the residual frame time of the frame F1 (e.g. 25%). In other words, the OLED 146 is turned off in ¾ of the frame F1. Therefore, when the scan signal Scan of the next frame F2 is enabled, the displayed image will have a flicker issue.

Regarding to the flicker issue, the conventional solution is to increase the frequency of the scan signals. In the above example, the frequency of the scan signals must be increased to four time of the original to eliminate the flicker issue. Unfortunately, this solution will cause the increase of power consumption and need a more complex circuit design, and thus is not a suitable solution. Since the loads on different scan lines are varied, the pixels connected to the scan line may not be properly renewed if the frequency of the scan signals increases. Besides, the general LED display panel also has the above-mentioned flicker issue.

Therefore, it is desired to properly solve the flicker issue of the LED (OLED) display panel.

### SUMMARY OF THE INVENTION

An objective of the present invention is to provide a display panel and a pixel circuit that can solve the flicker issue caused by the short duty cycle of pixels.

To achieve the above objective, the present invention discloses a pixel circuit, which includes a lighting element, a driving signal generating unit and a switching unit. The driving signal generating unit compares a data signal with a reference signal so as to generate a PWM driving signal. The status of the PWM driving signal is determined according to a comparing result of the data signal and the reference signal. The switching unit is electrically connected to a power source and the lighting element, and generates a driving current to drive the lighting element to emit light according to the PWM driving signal.

In one embodiment, the switching unit is a first transistor having a first source/drain optionally electrically connected to the power source or coupled to the power source through the lighting element, a second source/drain optionally grounded through the lighting element or directly grounded, and a gate electrically connected to the driving signal generating unit for receiving the PWM driving signal.

In one embodiment, the lighting element is a light-emitting diode (LED) or an organic light-emitting diode (OLED).

In one embodiment, the driving signal generating unit includes a comparator, a second transistor and a capacitor. The comparator has a first input end and a second input end for receiving the reference signal. The second transistor receives the data signal outputted from a data line and a scan signal outputted from a scan line. The second transistor is electrically connected to the first input end of the comparator for transmitting the data signal to the first input end according to a status of the scan signal. The capacitor has one end electrically connected to the first input end and another end grounded for storing a level of the data signal so as to generate an input voltage. The comparator compares the level of the data signal with the reference signal so as to generate the PWM driving signal.

In one embodiment, when a level of the reference signal is larger than a level of the input voltage, the comparator outputs the PWM driving signal of a first status. Otherwise, when the level of the reference signal is smaller than the level of the input voltage, the comparator outputs the PWM driving signal of a second status.

In one embodiment, the reference signal is a triangular wave signal, a square wave signal, or a sine wave signal.

To achieve the above objective, the present invention also discloses a display panel, which includes a substrate and a plurality of pixel circuits arranged on the substrate. At least one of the pixel circuits includes a lighting element, a driving signal generating unit and a switching unit. The driving signal generating unit includes a data signal with a reference signal so as to generate a PWM driving signal. The status of the PWM driving signal is determined according to a comparing result of the data signal and the reference signal. The switching unit is electrically connected to a power source and the lighting element, and generates a driving current to drive the lighting element to emit light according to the PWM driving signal.

In one embodiment, the switching unit is a first transistor having a first source/drain optionally electrically connected to the power source or coupled to the power source through the lighting element, a second source/drain optionally grounded through the lighting element or directly grounded, and a gate electrically connected to the driving signal generating unit for receiving the PWM driving signal.

In one embodiment, the lighting element is a light-emitting diode (LED) or an organic light-emitting diode (OLED).

In one embodiment, the driving signal generating unit includes a comparator, a second transistor and a capacitor. The comparator has a first input end and a second input end for receiving the reference signal. The second transistor receives the data signal outputted from a data line and a scan signal outputted from a scan line. The second transistor is electrically connected to the first input end of the comparator for transmitting the data signal to the first input end according to a status of the scan signal. The capacitor has one end electrically connected to the first input end and another end grounded for storing a level of the data signal so as to generate an input voltage. The comparator compares the level of the data signal with the reference signal so as to generate the PWM driving signal.

In one embodiment, when a level of the reference signal is larger than a level of the input voltage, the comparator outputs the PWM driving signal of a first status, and when the level of the reference signal is smaller than the level of the input voltage, the comparator outputs the PWM driving signal of a second status.

In one embodiment, the display panel further includes a plurality of scan lines, a plurality of data lines and a plurality of reference signal lines. The scan lines are electrically connected to the pixel circuits for transmitting the scan signal. Herein, the scan lines extend along a first direction and arranged in parallel along a second direction, which is substantially perpendicular to the first direction. The data lines are electrically connected to the pixel circuits for transmitting the data signal. Herein, the scan lines extend along the second direction and arranged in parallel along the first direction. The data lines are intercrossed with the scan lines so as to define a plurality of pixel areas, and the pixel circuits are arranged in the pixel areas, respectively. The reference signal lines are electrically connected to the pixel circuits for transmitting corresponding reference signals.

In one embodiment, the reference signal lines are arranged in parallel along the first direction or the second direction, and a waveform of the reference signal transmitted through at least one of the reference signal lines is different from a waveform of the reference signal transmitted through another one of the reference signal lines.

In one embodiment, the reference signals transmitted through of the reference signal lines are all the same.

In one embodiment, the reference signal is a triangular wave signal, a square wave signal, or a sine wave signal.

As mentioned above, the present invention can compare the data signal with a reference signal so as to generate a PWM driving signal for driving the lighting element to emit light. Accordingly, the flicker issue of the displayed image can be prevented. In addition, when the image has flicker, it is simply to increase the frequency of the reference signal Vref so as to eliminate the flicker phenomenon. Thus, this invention can easily solve the flicker issue without complex circuit and large power consumption.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is an equivalent circuit diagram of a conventional analog driving OLED pixel;

FIG. 1B is an equivalent circuit diagram of a conventional digital driving OLED pixel;

FIG. 1C is a signal timing chart of the OLED pixel of FIG. 1B;

FIG. 2 is a block diagram of a pixel circuit according to a preferred embodiment of the invention;

FIG. 3A is a circuit diagram of a comparator according to a first embodiment of the invention;

FIG. 3B is a circuit diagram of a comparator according to a second embodiment of the invention;

FIG. 4A is a signal timing chart of the pixel circuit of FIG. 2 according to the first embodiment of the invention;

FIG. 4B is a signal timing chart of the pixel circuit of FIG. 2 according to the second embodiment of the invention;

FIG. 4C is a signal timing chart of the pixel circuit of FIG. 2 according to the third embodiment of the invention;

FIG. 5 is a block diagram of a display device according to the preferred embodiment of the invention; and

FIG. 6 is a signal timing chart of the display panel of FIG. 5 according to an embodiment of the invention.

### DETAILED DESCRIPTION OF THE INVENTION

The present invention will be apparent from the following detailed description, which proceeds with reference to the accompanying drawings, wherein the same references relate to the same elements.

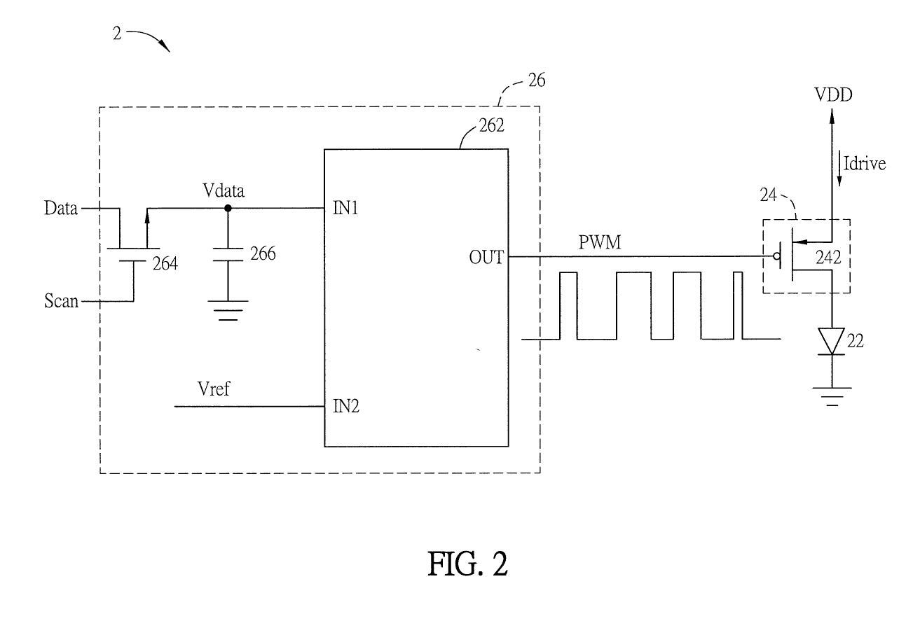

FIG. 2 is a block diagram of a pixel circuit according to a preferred embodiment of the invention. As shown in FIG. 2, the pixel circuit 2 of this embodiment includes a lighting element 22, a switching unit 24, a driving signal generating unit 26, and a power source VDD. One end of the switching unit 24 is electrically connected to the lighting element 22, and the other end of the switching unit 24 is electrically connected to the power source VDD. Besides, the switching unit 24 is further electrically connected to the driving signal generating unit 26. In this embodiment, the pixel circuit is an active matrix circuit and can be applied to various kinds of display devices, such as the outdoor media board, illumination device, OLED display device, LED display device, and the likes. This invention is not limited.

The driving signal generating unit 26 receives data signal Data from a data line and a scan signal Scan from a scan line, and then compares the data signal Data with a reference signal Vref so as to output a pulse width modulation (PWM) driving signal PWM to the switching unit 24. Then, the switching unit 24 generates a driving current Idrive to drive the lighting element 22 to emit light according to the PWM driving signal PWM. Preferably, the driving current Idrive is constant, but this invention is not limited.

The switching unit 24 can be carried out by a first transistor 242. In this embodiment, the first transistor 242 is a PMOS transistor, but this invention is not limited. The first source/drain (source) of the first transistor 242 is electrically connected to the power source VDD, and the second source/drain (drain) of the first transistor 242 is electrically connected to the lighting element 22 and then grounded through the lighting element 22. In another embodiment, the source of the first transistor 242 is coupled to the power source VDD through the lighting element 22, and the drain of the first transistor 242 is directly grounded. In this current embodiment, the lighting element 22 is an OLED having one end connected to the first transistor 242 and the other end grounded. In another embodiment, the lighting element 22 can also be an inorganic LED, and this invention is not limited.

Referring to FIG. 2, the driving signal generating unit 26 includes a comparator 262, a second transistor 264 and a capacitor 266. The drain of the second transistor 264 is electrically connected to the data signal Data, the source of the second transistor 264 is electrically connected to the comparator 262, and the gate of the second transistor 264 is electrically connected to the scan signal Scan. One end of the capacitor 266 is electrically connected to the second transistor 264, and the other end of the capacitor 266 is grounded. In this embodiment, the second transistor 264 is, for example, an NMOS transistor.

The comparator 262 has a first input end IN1, a second input end IN2, and an output end OUT. The first input end IN1 is electrically connected to the source of the second transistor 264, and the second input end IN2 receives the reference signal Vref. The output end OUT of the comparator 262 is electrically connected to the gate of the first transistor 242 for transmitting the PWM driving signal PWM to the first transistor 242.

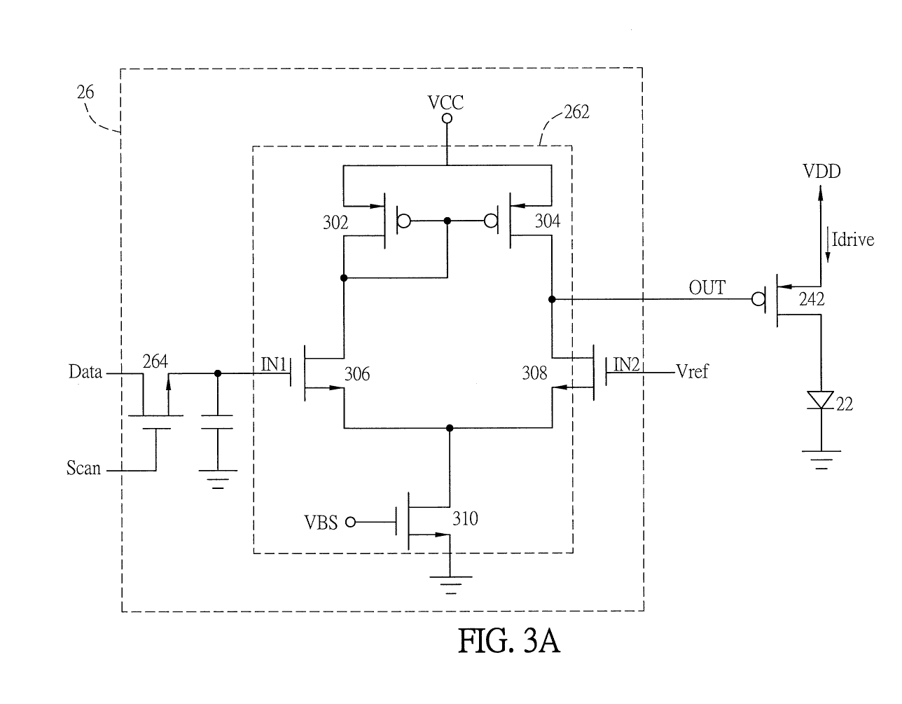

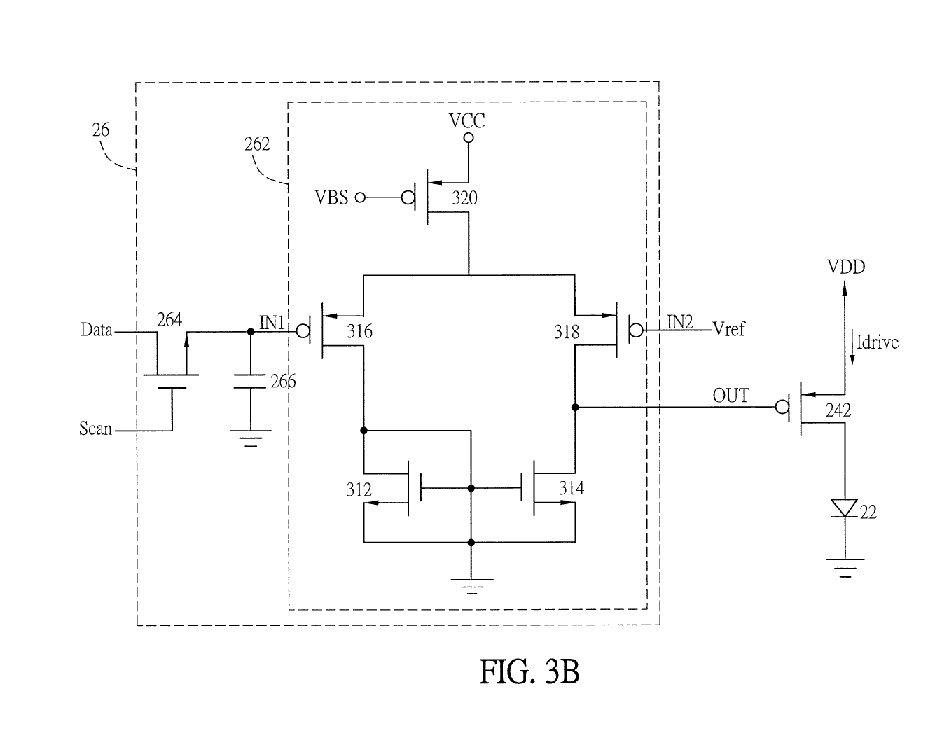

FIG. 3A is a circuit diagram of a comparator according to a first embodiment of the invention. As shown in FIG. 3A, the comparator 262 includes transistors 302, 304, 306, 308 and 310. In this case, the transistors 302 and 304 are PMOS transistors, and the transistors 306, 308 and 310 are NMOS transistors. The sources of the transistors 302 and 304 are electrically connected to the power source VCC, and the gates of the transistors 302 and 304 are electrically connected to each other. The gate and drain of the transistor 302 are electrically connected to each other. The drains of the transistors 306 and 308 are electrically connected to the drains of the transistor 302 and 304, respectively. The drain of the transistor 308 is electrically connected to the output end OUT of the comparator 262 and further electrically connected to the gate of the first transistor 242 through the output end OUT. The gate of the transistor 306 is the first input end IN1 and electrically connected to the source of the second transistor 264. The gate of the transistor 308 is the second input end IN2 and electrically connected to the reference signal Vref. The drain of the transistor 310 is electrically connected to the sources of the transistors 306 and 308, the gate of the transistor 310 is electrically connected to the bias voltage VBS, and the source of the transistor 310 is grounded.

FIG. 3B is a circuit diagram of a comparator according to a second embodiment of the invention. As shown in FIG. 3B, the comparator 262 includes transistors 312, 314, 316, 318 and 320. In this case, the transistors 312 and 314 are NMOS transistors, and the transistors 316, 318 and 320 are PMOS transistors. The sources of the transistors 312 and 314 are grounded, and the gates of the transistors 312 and 314 are electrically connected to each other. The gate and drain of the transistor 312 are electrically connected to each other. The drains of the transistors 316 and 318 are electrically connected to the drains of the transistor 312 and 314, respectively. The drain of the transistor 318 is electrically connected to the output end OUT of the comparator 262 and further electrically connected to the gate of the first transistor 242 through the output end OUT. The gate of the transistor 316 is the first input end IN1 and electrically connected to the source of the second transistor 264. The gate of the transistor 318 is the second input end IN2 and electrically connected to the reference signal Vref. The drain of the transistor 320 is electrically connected to the sources of the transistors 316 and 318, the gate of the transistor 320 is electrically connected to the bias voltage VBS, and the source of the transistor 310 is electrically connected to the power source VCC.

To be noted, the above-mentioned comparators and the circuits thereof are not to limit the present invention, and those skilled persons should know that using different comparator circuits is still within the scope and spirit of the invention.

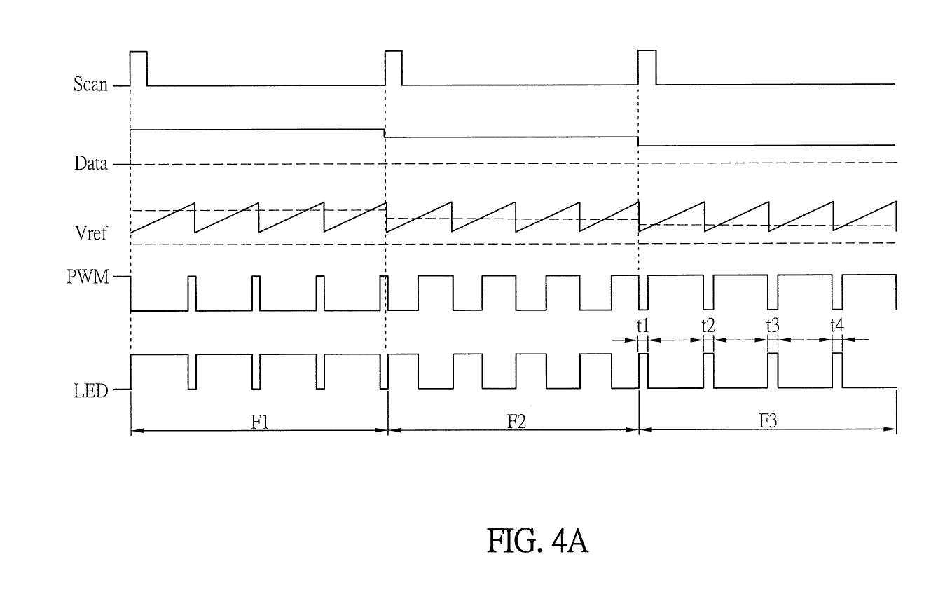

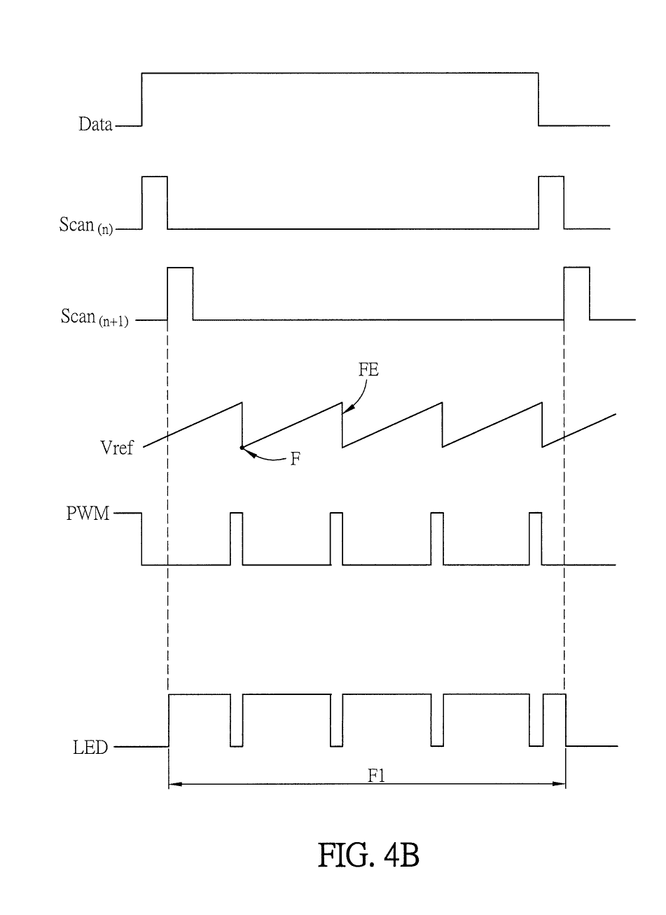

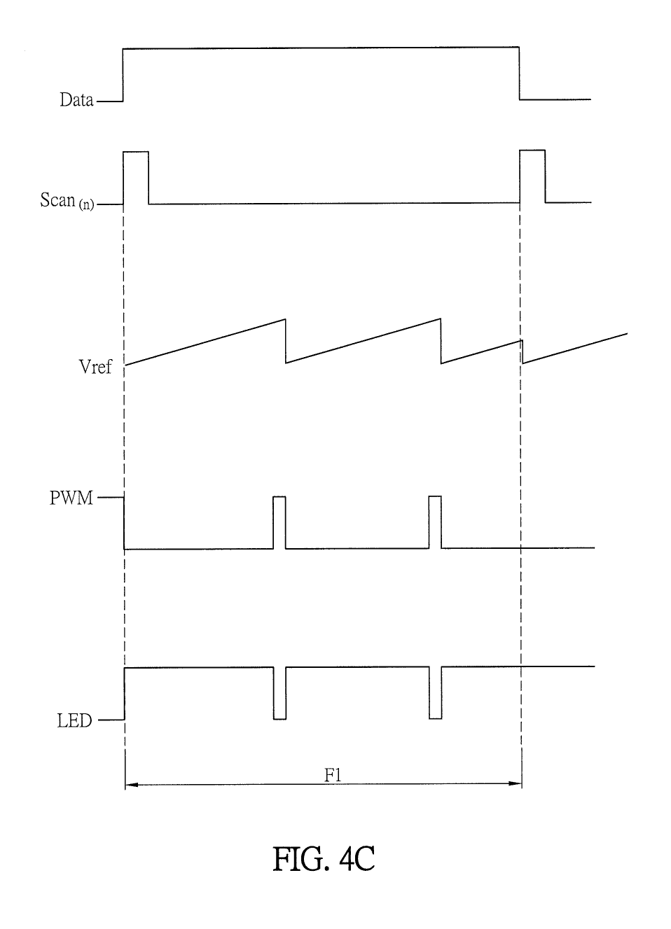

FIG. 4A is a signal timing chart of the pixel circuit of FIG. 2 according to the first embodiment of the invention. Referring to FIGS. 2 and 4A, the frame times F1, F2 and F3 are indicated in the drawings. When the scan signal Scan is enabled, one frame time is initiated and the second transistor 264 is turned on. At this moment, the data signal Data is transmitted through the second transistor 264 and then stored in the capacitor 266. Accordingly, the first input end IN1 of the comparator 262 receives the data signal voltage Vdata, so that the comparator 262 can compare the data signal voltage Vdata with the reference signal Vref.

In this embodiment, the reference signal Vref is a triangular wave signal, but this invention is not limited thereto. In other embodiments, the reference signal Vref can be a sine wave signal, a square wave signal, a pulse signal, or the likes. When the level of the reference signal Vref is lower than that of the data signal Data (the level of the data signal voltage Vdata as the dotted line shown in the figure), the comparator 262 will output a low level PWM driving signal PWM. Alternatively, when the level of the reference signal Vref is higher than that of the data signal Data, the comparator 262 will output a high level PWM driving signal PWM. When the PWM driving signal PWM is in a low level, the first transistor 242 is enabled to generate the driving current Idrive to drive the lighting element 22 (e.g. an LED) to emit light. In another case, if the first transistor 242 is an NMOS transistor, it will be enabled to drive the lighting element 22 to emit light as the PWM driving signal PWM is in a high level.

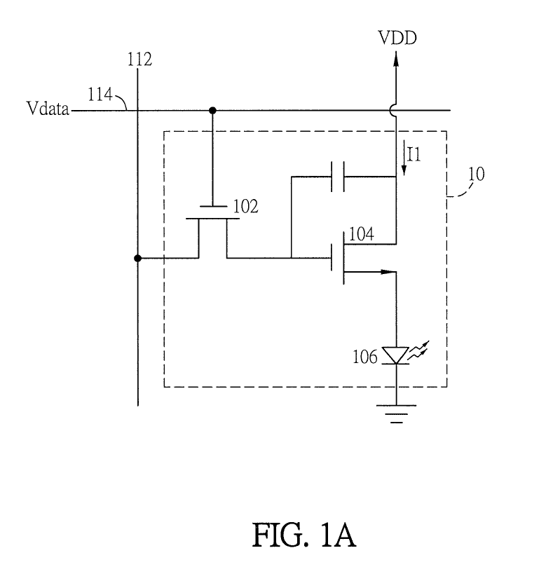

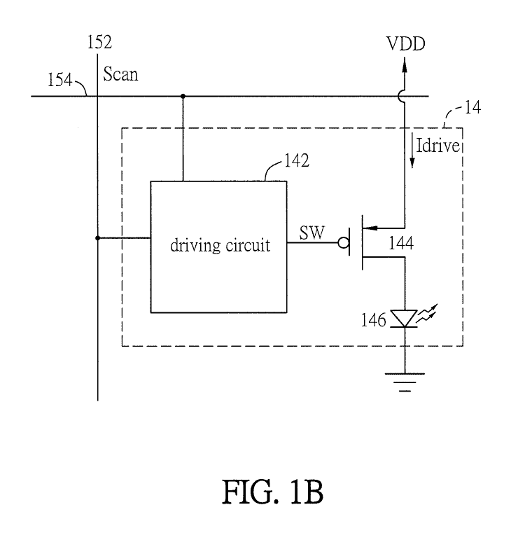

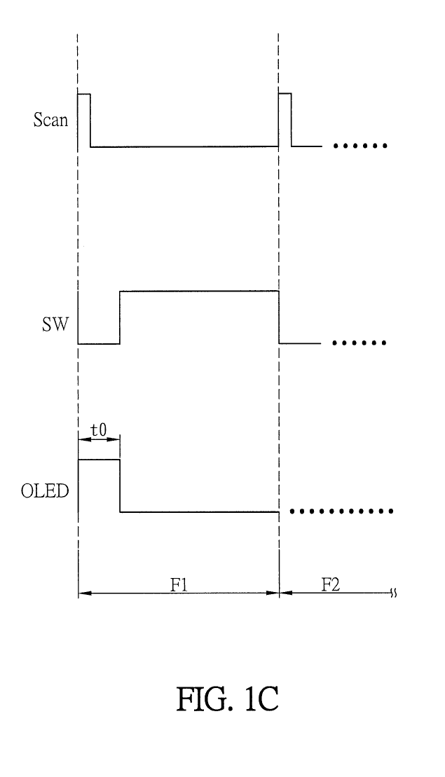

In this invention, the lighting element 22 is driven by the PWM driving signal PWM, and the PWM driving signal PWM is generated according to the comparison result of the data signal Data and the reference signal Vref. Herein, the frequency of the reference signal Vref is larger than the renewal frequency of the frame. Preferably, the frequency of the reference signal Vref is multiple times (e.g. four, five or six times) of the renewal frequency of the frame. Accordingly, if the lighting element 22 is driven with a non-fully brightness (e.g. 50% brightness), this non-fully brightness period is shorter. Taking the 25% brightness as an example, the light emitted by the OLED 146 of FIG. 1C will focus in the time period t0. If a frame time is X, the time period that the OLED 146 is turned off is X-t0. Regarding to the frame time F3 of FIG. 4A, the lighting element 22 is driven with a 25% brightness, and it is turned on in the time periods t1, t2, t3 and t4. In other words, the lighting frequency of the lighting element 22 is larger than the lighting frequency of the OLED 146 of FIG. 1C. Accordingly, the flicker phenomenon of the pixel can be solved. In addition, the start point F of the reference signal Vref is aligned with the start time of the scan signal Scan₍ₙ₊₁₎. Thus, the time periods for turning on the lighting element 22 are averagely distributed in the frame time F1.

In general, human eyes can view the flicker images with the lighting frequency lower than 180 Hz, and some sensitive eyes can view the flicker images with the lighting frequency lower than 240 Hz. In this invention, if the image still has the flicker phenomenon, the user can simply increase the frequency of the reference signal Vref to eliminate the flicker phenomenon. For example, the reference signal Vref can be adjusted to increase the lighting frequency (over 180 Hz, and preferably over 240 Hz) of the lighting element 22 in the frame time F1, and the complex procedure in the conventional art is not needed.

FIG. 4B is a signal timing chart of the pixel circuit of FIG. 2 according to the second embodiment of the invention. As shown in FIG. 4B, the start point F of the reference signal Vref is not aligned with the start time of the scan signal Scan₍ₙ₊₁₎. Thus, the time periods for turning on the lighting element 22 are not averagely distributed in the frame time F1. To be noted, the start point F of the reference signal Vref can be aligned with the start time of the scan signal Scan₍ₙ₊₁₎ or not depending on the actual situations, and this invention is not limited.

FIG. 4C is a signal timing chart of the pixel circuit of FIG. 2 according to the third embodiment of the invention. As shown in FIG. 4C, the waveform of the reference signal Vref is irregular. Accordingly, the time periods for turning on the lighting element 22 are also not averagely distributed in the frame time.

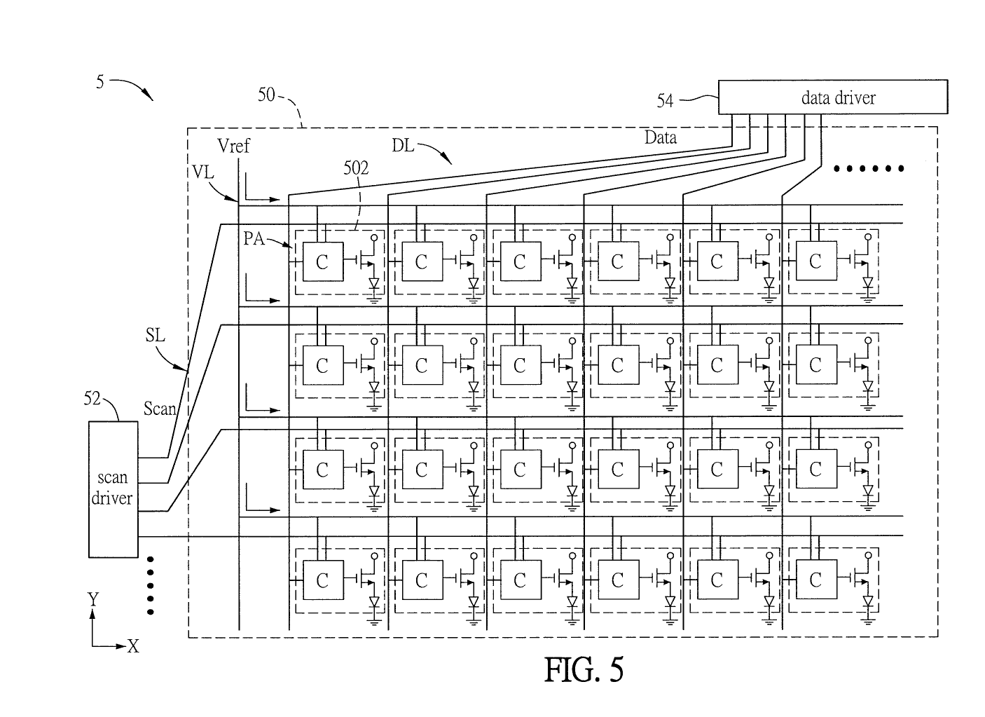

FIG. 5 is a block diagram of a display device according to the preferred embodiment of the invention. Referring to FIG. 5, the display device 5 includes a display panel 50, a plurality of scan lines SL and a plurality of data lines DL. The scan lines extend along the direction X, and are arranged in parallel along the direction Y The data lines extend along the direction Y, and are arranged in parallel along the direction X. One scan line SL and one data line DL are intercrossed to define a pixel area PA. To be noted, the scan line SL and the data line DL are not directly contacted. In addition, each pixel area PA is configured with at least one pixel circuit (502), and at least one of the pixel circuits utilizes the pixel circuit structure of FIG. 2. In this embodiment, all pixel circuits of the display panel 50 utilize the pixel circuit structure of FIG. 2. Each pixel circuit is correspondingly electrically connected to one scan line SL and one data line DL.

In addition, the display device 5 further includes a scan driver 52 and a data driver 54. The scan driver 52 is electrically connected to the scan lines SL for outputting the scan signals Scan through the scan lines SL. The data driver 54 is electrically connected to the data lines DL for outputting the data signals Data through the data lines DL.

In particular, the display device 5 further includes a plurality of reference signal lines VL, which are arranged on the display panel 50 and electrically connected to the pixel circuits of the display panel 50, respectively. The reference signal lines VL transmit the reference signals Vref to the electrically connected pixel circuits. In some embodiments, the waveform of one reference signal Vref transmitted from one of the reference signal lines VL is different from the waveform of another reference signal Vref transmitted from another one of the reference signal lines VL. In this embodiment, the waveforms of all reference signals Vref transmitted from the reference signal lines VL are the same, and this invention is not limited.

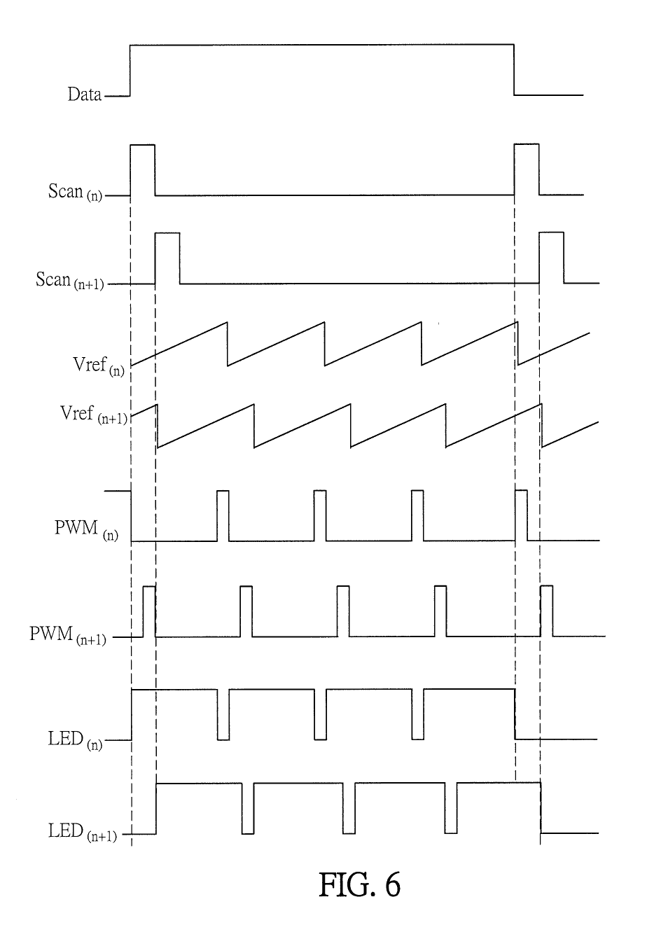

FIG. 6 is a signal timing chart of the display panel of FIG. 5 according to an embodiment of the invention. Referring to FIG. 6, the waveform of the reference signal Vref₍ₙ₎ transmitted from the n^{th} reference signal line is different from the waveform of the reference signal Vref₍ₙ₊₁₎ transmitted from the (n+1)^{th} reference signal line. Accordingly, the lighting modes of the lighting element LED₍ₙ₎ on the n^{th} scan line and the lighting element LED₍ₙ₊₁₎ on the (n+1)^{th} scan line are different.

As shown in FIG. 5, the entire display panel can use a single reference signal Vref, so the adjustment becomes very simple. Of course, it is also possible to design that only a part of the display panel uses a single reference signal Vref, thereby maintaining the system design flexibility.

In summary, the present invention can compare the data signal with a reference signal so as to generate a PWM driving signal for driving the lighting element to emit light. Accordingly, the flicker issue of the displayed image can be prevented. In addition, when the image has flicker, it is simply to increase the frequency of the reference signal Vref so as to eliminate the flicker phenomenon. Thus, this invention can easily solve the flicker issue without complex circuit and large power consumption.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A pixel circuit, comprising:
a lighting element;
a driving signal generating unit comparing a data signal with a reference signal so as to generate a PWM driving signal, wherein a status of the PWM driving signal is determined according to a comparing result of the data signal and the reference signal; and
a switching unit electrically connected to a power source and the lighting element, wherein the switching unit generates a driving current to drive the lighting element to emit light according to the PWM driving signal.

2. The pixel circuit of claim 1, wherein the switching unit is a first transistor having a first source/drain optionally electrically connected to the power source or coupled to the power source through the lighting element, a second source/drain optionally grounded through the lighting element or directly grounded, and a gate electrically connected to the driving signal generating unit for receiving the PWM driving signal.

3. The pixel circuit of claim 1, wherein the lighting element is a light-emitting diode or an organic light-emitting diode.

4. The pixel circuit of claim 1, wherein the driving signal generating unit comprises:
a comparator having a first input end and a second input end for receiving the reference signal;
a second transistor receiving the data signal outputted from a data line and a scan signal outputted from a scan line, wherein the second transistor is electrically connected to the first input end of the comparator for transmitting the data signal to the first input end according to a status of the scan signal; and
a capacitor having one end electrically connected to the first input end and another end grounded for storing a level of the data signal so as to generate an input voltage;
wherein the comparator compares the level of the data signal with the reference signal so as to generate the PWM driving signal.

5. The pixel circuit of claim 4, wherein when a level of the reference signal is larger than a level of the input voltage, the comparator outputs the PWM driving signal of a first status, and when the level of the reference signal is smaller than the level of the input voltage, the comparator outputs the PWM driving signal of a second status.

6. The pixel circuit of claim 1, wherein the reference signal is a triangular wave signal, a square wave signal, or a sine wave signal.

7. A display panel, comprising:
a substrate; and
a plurality of pixel circuits arranged on the substrate, wherein at least one of the pixel circuits comprises:
a lighting element,
a driving signal generating unit comparing a data signal with a reference signal so as to generate a PWM driving signal, wherein a status of the PWM driving signal is determined according to a comparing result of the data signal and the reference signal, and
a switching unit electrically connected to a power source and the lighting element, wherein the switching unit generates a driving current to drive the lighting element to emit light according to the PWM driving signal.

8. The display panel of claim 7, wherein the switching unit is a first transistor having a first source/drain optionally electrically connected to the power source or coupled to the power source through the lighting element, a second source/drain optionally grounded through the lighting element or directly grounded, and a gate electrically connected to the driving signal generating unit for receiving the PWM driving signal.

9. The display panel of claim 7, wherein the lighting element is a light-emitting diode (LED) or an organic light-emitting diode (OLED).

10. The display panel of claim 7, wherein the driving signal generating unit comprises:
a comparator having a first input end and a second input end for receiving the reference signal;
a second transistor receiving the data signal outputted from a data line and a scan signal outputted from a scan line, wherein the second transistor is electrically connected to the first input end of the comparator for transmitting the data signal to the first input end according to a status of the scan signal; and
a capacitor having one end electrically connected to the first input end and another end grounded for storing a level of the data signal so as to generate an input voltage;
wherein the comparator compares the level of the data signal with the reference signal so as to generate the PWM driving signal.

11. The display panel of claim 10, wherein when a level of the reference signal is larger than a level of the input voltage, the comparator outputs the PWM driving signal of a first status, and when the level of the reference signal is smaller than the level of the input voltage, the comparator outputs the PWM driving signal of a second status.

12. The display panel of claim 8, further comprising:
a plurality of scan lines electrically connected to the pixel circuits for transmitting the scan signal, wherein the scan lines extend along a first direction and arranged in parallel along a second direction, which is substantially perpendicular to the first direction;
a plurality of data lines electrically connected to the pixel circuits for transmitting the data signal, wherein the scan lines extend along the second direction and arranged in parallel along the first direction, the data lines are intercrossed with the scan lines so as to define a plurality of pixel areas, and the pixel circuits are arranged in the pixel areas, respectively; and
a plurality of reference signal lines electrically connected to the pixel circuits for transmitting corresponding reference signals.

13. The display panel of claim 12, wherein the reference signal lines are arranged in parallel along the first direction or the second direction, and a waveform of the reference signal transmitted through at least one of the reference signal lines is different from a waveform of the reference signal transmitted through another one of the reference signal lines.

14. The display panel of claim 12, wherein the reference signals transmitted through of the reference signal lines are all the same.

15. The display panel of claim 7, wherein the reference signal is a triangular wave signal, a square wave signal, or a sine wave signal.
